(19) United States
(12) Patent Application Publication
(10) Pub. No.: US 2007/0047699 A1
(43) Pub. Date: Mar. 1, 2007

(54) Separation of session and session control

(75) Inventors: Raheel Yuhanna, Dallas, TX (US); R. Alberto Villarica, Dallas, TX (US); Yahya Idrissi, Plano, TX (US)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 11/214,394

(22) Filed: Aug. 29, 2005

(51) Int. Cl. H04M 11/00

(52) U.S. Cl. 379/93.09

(57) ABSTRACT

The present invention allows a media terminal to initiate or receive a first communication session, and a control terminal to control the first communication session. The media and control terminals are generally proximate to or otherwise associated with each other. The control terminal may provide additional services associated with the communication session or for the media terminal. In addition to providing control and supporting additional services, the control terminal may support communication sessions associated with the first communication session involving the media terminal. A service node is provided to communicate with the media and control terminals to allow the control terminal to control the first communication session.

### FIELD OF THE INVENTION

The present invention relates to communications, and in particular to allowing a first communication terminal to initiate or receive a communication session and allowing a second communication terminal to control the communication session.

### BACKGROUND OF THE INVENTION

The rapid acceptance and growth of packet-based networks has led to the development of numerous multimedia services, which are beneficial in both residential and business contexts. These multimedia services include application sharing, video conferencing, media streaming, gaming, and the like. The multimedia services are predominantly provided over packet-based networks between various media clients, which are generally implemented on a personal computer. Most of the multimedia services benefit when a voice connection is concurrently established between the end users. In a video conferencing environment, the conferencing parties need a voice connection to enable the conversation, yet may require media sessions to provide the associated video or share application information between the conferencing parties. Although packet-based networks are sufficient to facilitate the multimedia services, the corresponding voice connection is generally set up independently over a circuit-switched network. When voice-over-packet sessions are viable, there is generally one communication terminal that is better for handling the video while another communication terminal is better for handling the audio. For either voice or packet based calls, video systems generally do not provide the level of quality that is desired for audio, and telephony terminals generally do not provide the level of quality that is desired for video.

Further, multimedia sessions are subject to an extensive set of services, given their ability to be associated with each other and be readily moved from one communication terminal to another. Unfortunately, it is often difficult or cumbersome for the user to provide control of the sessions or services associated therewith during the multimedia session. When different sessions for a multimedia session involve different communication terminals of a given user, there is no way for one communication terminal to control the session afforded by the other communication terminal. In many instances, control is either provided predominately from a centralized entity or the user will have to interact with each of the communication terminals independently. Such lack of control inhibits users from fully using the features made possible in multimedia environments.

Given the ever-increasing popularity of multimedia sessions, there is a need for an efficient and effective technique for automatically associating different sessions of a multimedia session where the different sessions are established with different communication terminals of a given user. There is a further need for a technique to allow the user to better control these different sessions and any available services associated with any of the different communication terminals from one communication terminal.

### SUMMARY OF THE INVENTION

The present invention allows a media terminal to initiate or receive a first communication session, and a control terminal to control the first communication session. The media and control terminals are generally proximate to or otherwise associated with each other. The control terminal may provide additional services associated with the communication session or for the media terminal. In addition to providing control and supporting additional services, the control terminal may support communication sessions associated with the first communication session involving the media terminal. A service node is provided to communicate with the media and control terminals to allow the control terminal to control the first communication session.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIG. 2 is a communication flow diagram illustrating an embodiment where user information is presented for display to a control device.

FIG. 3 is a communication flow diagram illustrating an embodiment where a call is transferred using the control device.

FIGS. 4A-4C illustrate a communication flow diagram illustrating an embodiment wherein a conference call is set up using the control device.

FIG. 5 is a block representation of a service node according to one embodiment of the present invention.

FIG. 6 is a block representation of a media terminal according to one embodiment of the present invention.

FIG. 7 is a block representation of a control terminal according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention allows a first communication terminal to initiate or receive a communication session, and a second communication terminal to control the communication session. The first and second communication terminals are typically proximate to or otherwise associated with each other. The second communication terminal may provide additional services associated with the communication session or for the first communication terminal. In addition to providing control and supporting additional services, the second communication terminal may support other communication sessions with the first communication terminal or other entities. The other communication sessions may be associated with the communication session involving the first communication terminal. A centralized service entity, referred to herein as a service node, is provided to communicate with the first and second communication terminals to facilitate the second communication terminal's control of the communication session involving the first communication terminal.

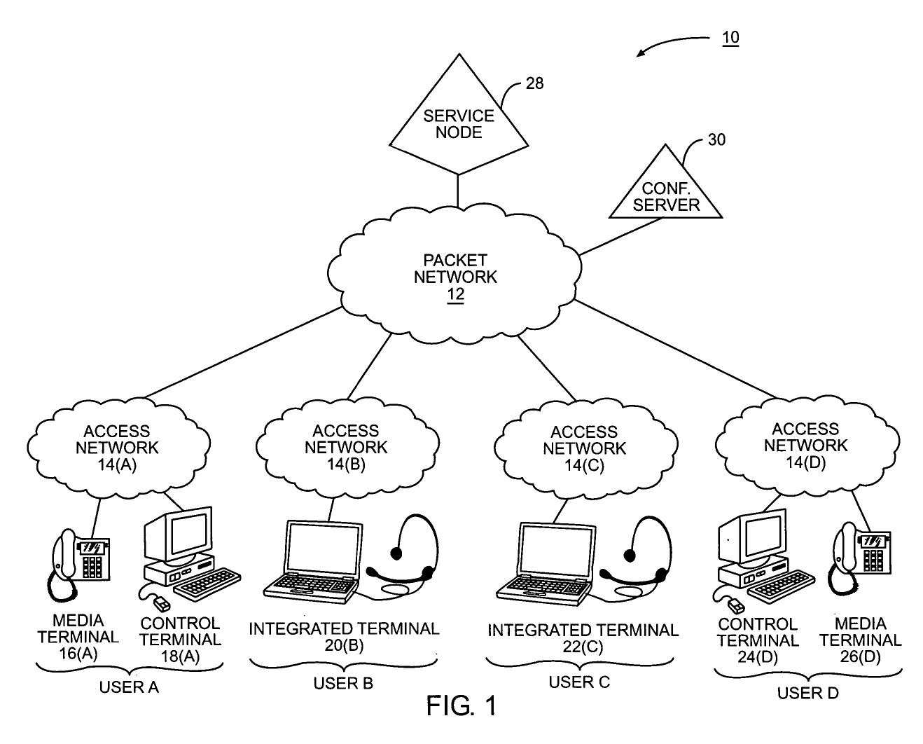

Prior to delving into the details of the present invention, an overview of the communication environment according to one embodiment of the present invention is provided. With reference to FIG. 1, a communication environment 10 is illustrated wherein a packet network 12 and any number of access networks 14 allow different types of communication terminals to communicate with one another. The communication terminals may interact with the corresponding access networks 14 using wired or wireless access techniques to implement packet based or circuit-switched communications. Accordingly, certain of the access networks 14 may represent or form part of a cellular communication network, the Public Switched Telephone Network (PSTN), an Internet Protocol (IP) based network, a local area network (LAN), a wireless local area network (WLAN), or the like. The packet network 12 or the associated access networks 14 may employ one or more media gateways (not shown) to facilitate interworking between the different communication architectures to support communication sessions between the various communication terminals supported by the various access networks 14.

For the sake of conciseness and clarity in describing the select embodiments of the present invention, the communication terminals are characterized as media terminals, control terminals, or integrated terminals. Regardless of the designation, each of the communication terminals may take various forms, including mobile terminals, telephones, personal computers, personal digital assistants (PDAs), or other communication devices. As noted, the present invention allows one communication terminal to control the communication sessions associated with another communication terminal. Accordingly, the communication terminals taking a primary role in controlling another communication terminal's communication session are referred to as control terminals, wherein the communication terminals subjected to a control terminal's control are referred to as media terminals. Notably, both the control and media terminals may be able to provide control of their own communication sessions, and the control terminals, as well as the media terminals, may support communication sessions. The designation of “control” or “media” is used simply to differentiate one communication terminal from another when the control aspects of the present invention are being implemented. Integrated terminals are those that are capable of providing control for their own sessions in traditional fashion. The integrated terminals may communicate with each other as well as establish communications with other media terminals as well as control terminals, as will be illustrated further below.

As illustrated in FIG. 1, access network 14(A) supports a media terminal 16(A) and a control terminal 18(A) associated with User A. Integrated terminal 20(B) is supported by access network 14(B) and is associated with User B. Similarly, integrated terminal 22(C) is supported by access network 14(C) and is associated with User C. Control terminal 24(D) and media terminal 26(D) are supported by access network 14(D) and are associated with User D. In the following operation examples, communication sessions involving media terminal 16(A) are controlled, at least in part, by control terminal 18(A). Similarly, communication sessions involving media terminal 26(D) may be controlled, at least in part, by control terminal 24(D). The ability for the control terminals 18(A) and 24(D) to control their respective media terminals 16(A) and 26(D) is afforded by a service node 28, which may facilitate establishment of communication sessions among the various communication terminals, either directly or indirectly, as well as provide control of communication sessions involving media terminal 16(A) or 26(D) to control terminal 18(A) or 24(D), respectively. The service node 28 may provide additional information to the control terminals 18(A) and 24(D) to facilitate control of communication sessions involving media terminal 16(A) or 26(D), as well as to facilitate additional services. These services may involve establishing communications with other communication entities, which may include other communication terminals and other network devices. As illustrated, a conference server 30 may be used to facilitate audio or video conferencing, an example of which is provided below.

With respect to the media terminal 16(A) and control terminal 18(A) associated with User A, the service node 28 is configured to assist in establishing a communication session involving media terminal 16(A) and automatically turning control of the communication session over to control terminal 18(A). The service node 28 may provide information to aid control terminal 18(A) in controlling the communication session, as well as establishing or controlling additional services. These services may involve additional communication sessions involving media terminal 16(A), control terminal 18(A), a conference server 30, other communication device, or a combination thereof, as well as facilitate any type of function on or associated with any communication session. Notably, a second communication session, which is associated with the first communication session, may be established with control terminal 18(A). As such, the first and second communication sessions may be used for the audio and video portions of a video conference, respectively. With the present invention, both first and second communication sessions may be controlled by control terminal 18(A).

Although the following list is not inclusive and is merely exemplary, the service control afforded by control terminal 18(A) may facilitate establishing audio or video conferences, providing caller identification information or images, transferring calls, connecting calls, placing calls on hold, routing calls to voicemail, forwarding calls, and any other desired session control or service function. The service control may also include associating application and file sharing sessions or text-based messaging services, such as email, instant messaging, short messaging service messaging, and other sessions. Many of the traditional services may be supported with greater functionality and flexibility with the present invention. For example, a larger number of calls may be received, held, or connected to establish a conference. In addition to providing such control, the present invention allows the control to be effected in an efficient and effective manner by the user.

The present invention is particularly beneficial when media terminal 16(A) is a relatively basic communication terminal with respect to control terminal 18(A) from the perspective of the ability to control and support different types of sessions and services. For example, media terminal 16(A) may be a cellular telephone, wherein control terminal 18(A) may be a multimedia-enabled personal computer.

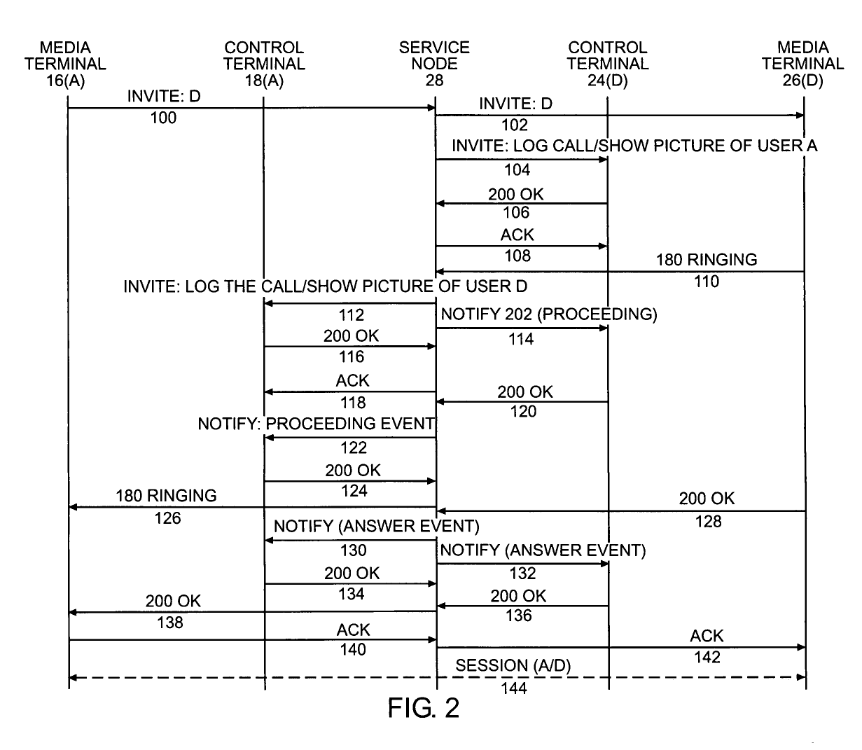

The following communication flows illustrate the operation and interaction of the various entities to implement different control functions. With reference to FIG. 2, an exemplary communication flow is provided wherein a communication session is established between media terminal 16(A) and media terminal 26(D). The session is initiated by media terminal 16(A), and during session establishment, images of the respective users A and D are provided in association with caller identification information at the control terminals 18(A) and 24(D). Accordingly, an enhanced caller identification service is facilitated in association with the established communication session. The communication flow follows.

For the present illustrations, the Session Initiation Protocol (SIP) is used to facilitate session signaling between the entities involved or the gateways supporting the entities. For clarity, it is assumed that all of the entities involved are packet based devices wherein communications may be established using SIP. Initially, media terminal 16(A) will send an Invite to initiate a session with media terminal 26(D) in response to an action taken by User A (step 100). The Invite is received by the service node 28, which may act as a proxy for either media terminal 16(A), media terminal 26(D), or both. Upon receipt of the Invite, the service node 28 will send an Invite toward media terminal 26(D) (step 102) as well as send an Invite to control terminal 24(D) to deliver information sufficient for logging the call as well as providing caller identification information and a picture of User A to control terminal 24(D), which is associated with User D (step 104). The service node 28 will be able to identify User A as the originator of the call and access the picture for delivery to control terminal 24(D). Upon receipt of the information, control terminal 24(D) will be able to deliver information bearing on the incoming call to User D, perhaps via a pop-up window on the display of control terminal 24(D). The information may include the caller identification and a picture of User A. Control terminal 24(D) will respond to the service node 28 by sending a 200 OK message (step 106). The service node 28 may send an acknowledgement message back to control terminal 24(D) upon receipt of the 200 OK message (step 108).

Meanwhile, media terminal 26(D) will generate a ringing signal for User D and send a 180 Ringing message to the service node 28 indicating that the ringing signal is being provided to User D (step 110). The service node 28 may access a picture of User D and provide the image, along with any call logging information, in an Invite sent to control terminal 18(A) of User A (step 112). Control terminal 18(A) may deliver call-related information in a pop-up window to User A. The information may include the picture of User D, along with any other call-related information, such as information identifying the number to which a call is being initiated, the name of User D, or any other pertinent information. Meanwhile, the service node 28 may send a Notify 202 message to control terminal 24(D) of User D to indicate that the call is proceeding (step 114). Control terminal 18(A) will respond with a 200 OK message in response to the Invite of step 112 to the service node 28 (step 116), which will respond with an acknowledgement message (step 118). Similarly, control terminal 24(D) will respond to the Notify 202 message by sending a 200 OK message to the service node 28 (step 120). The service node 28 may send a Notify message to control terminal 18(A) to indicate that the call initiation event is proceeding (step 122). Control terminal 18(A) will send a 200 OK message back to the service node 28 in response to the Notify message (step 124).

The service node 28 will also send a 180 Ringing message to media terminal 16(A) to indicate that media terminal 26(D) is ringing (step 126). When media terminal 26(D) is answered, a 200 OK message is sent to the service node 28 in response to the Invite of step 102 (step 128). The service node 28 will send a Notify message to control terminal 18(A) indicating that media terminal 26(D) has been answered (step 130). The service node 28 will send a similar Notify message to control terminal 24(D) indicating that media terminal 26(D) has been answered (step 132). Control terminals 18(A) and 24(D) will respond to the Notify messages by sending corresponding 200 OK messages back to the service node 28 (steps 134 and 136). Control terminals 18(A) and 24(D) may provide further information to the respective users A and D to alert them that media terminal 26(D) has been answered.

The service node 28 will also send a 200 OK message to media terminal 16(A) in response to the original Invite of step 100 (step 138). At this point, media terminal 16(A) will send an acknowledgement to the service node 28 (step 140), which will forward the acknowledgement to media terminal 26(D) (step 142), wherein a session between media terminals 16(A) and 26(D) is established for the call (step 144). As those skilled in the art will recognize, the various SIP messages may include session description protocol (SDP) information identifying the appropriate addresses, ports, codecs, and other information pertinent to providing the respective media terminals with sufficient information to support the session.

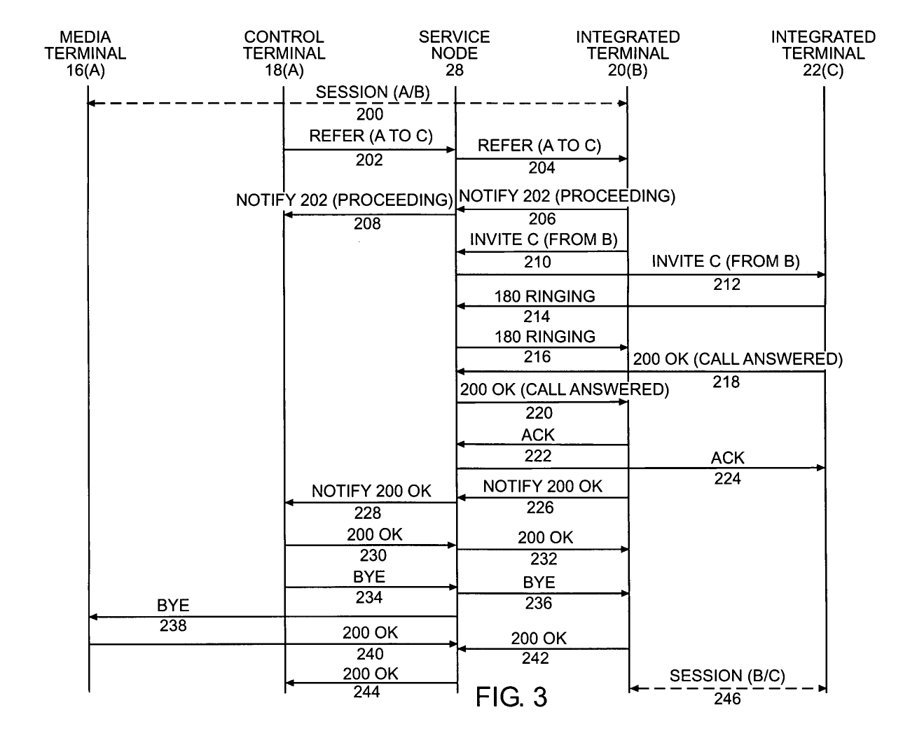

With reference to FIG. 3, a communication flow diagram is provided wherein a session supporting a call between media terminal 16(A) of User A and integrated terminal 20(B) of User B is transferred. The transfer results in a session being established between integrated terminal 20(B) of User B and integrated terminal 22(C) of User C. Initially, a session is established between media terminal 16(A) and integrated terminal 20(B), perhaps using a process similar to that described in association with FIG. 2 (step 200). Through interaction with control terminal 18(A), User A initiates a transfer of the session to integrated terminal 22(C). In response, control terminal 18(A) will send a Refer message to the service node 28 indicating the call should be transferred from media terminal 16(A) to integrated terminal 22(C) (step 202). The service node 28 will then send a Refer message to integrated terminal 20(B) indicating the session is to be transferred from media terminal 16(A) to integrated terminal 22(C) (step 204). Integrated terminal 20(B) will respond with a Notify 202 message indicating that the transfer is in progress, and may alert User B to the transfer request (step 206). The service node 28 may also send a Notify 202 message indicating that transfer is proceeding to control terminal 18(A) (step 208).

Integrated terminal 20(B) will then initiate an Invite to establish a session with integrated terminal 22(C). The Invite is received by the service node 28 (step 210), which will send an Invite to integrated terminal 22(C) to establish a session with integrated terminal 20(B) (step 212). Integrated terminal 22(C) will initiate ringing and send a 180 Ringing message to the service node 28 (step 214), which will send a 180 Ringing message to integrated terminal 20(B) to indicate that integrated terminal 22(C) is ringing (step 216). When answered, integrated terminal 22(C) will send a 200 OK message indicating the call was answered to the service node 28 (step 218), which will send a similar 200 OK message to integrated terminal 20(B) (step 220). Integrated terminal 20(B) may forward an acknowledgement to the 200 OK message to the service node 28 (step 222), which will send a similar acknowledgement to integrated terminal 22(C) (step 224). Integrated terminal 20(B) may then send a Notify message to control terminal 18(A) to indicate the call has been transferred via the service node 28 (steps 226 and 228). Control terminal 18(A) may provide an indication to User A that the transfer is taking place or has taken place, as well as send a 200 OK message toward integrated terminal 20(B) via the service node 28 in response to the Notify message (steps 230 and 232).

To end the session between media terminal 16(A) and integrated terminal 20(B), control terminal 18(A) may then send a Bye message to the service node 28 (step 234), which will send Bye messages to integrated terminal 20(B) (step 236) as well as media terminal 16(A) (step 238) to instruct media terminal 16(A) and integrated terminal 20(B) to end the communication session. 200 OK messages may be sent in response to each of the Bye messages (steps 240, 242, and 244). At this point, a session is established between integrated terminal 20(B) and integrated terminal 22(C) (step 246), wherein the call is effectively transferred from media terminal 16(A) to integrated terminal 22(C) under the control of control terminal 18(A).

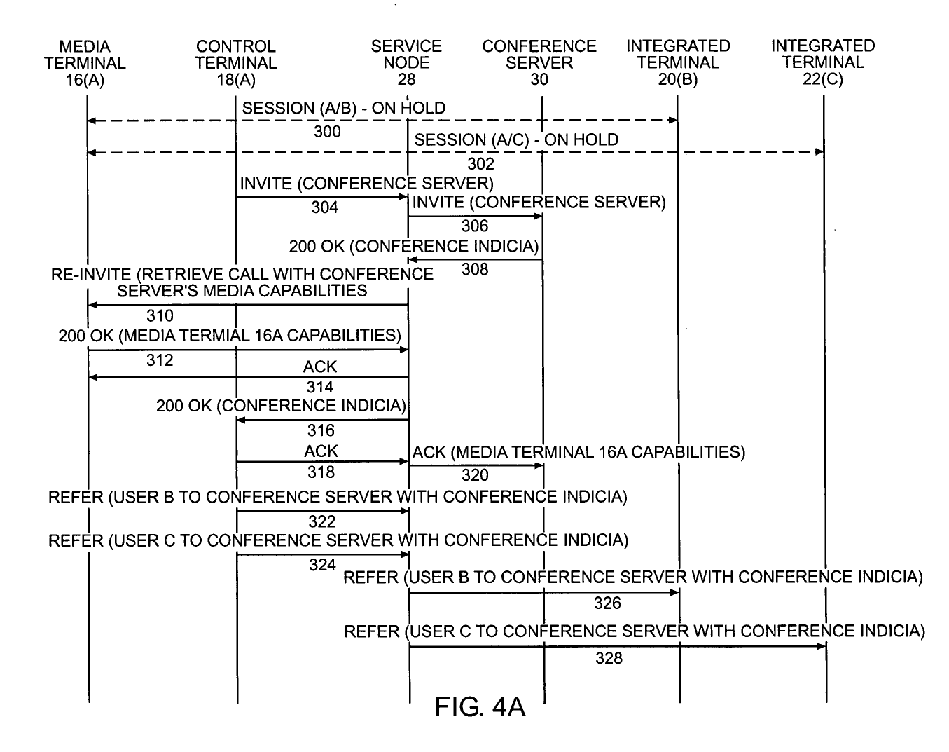

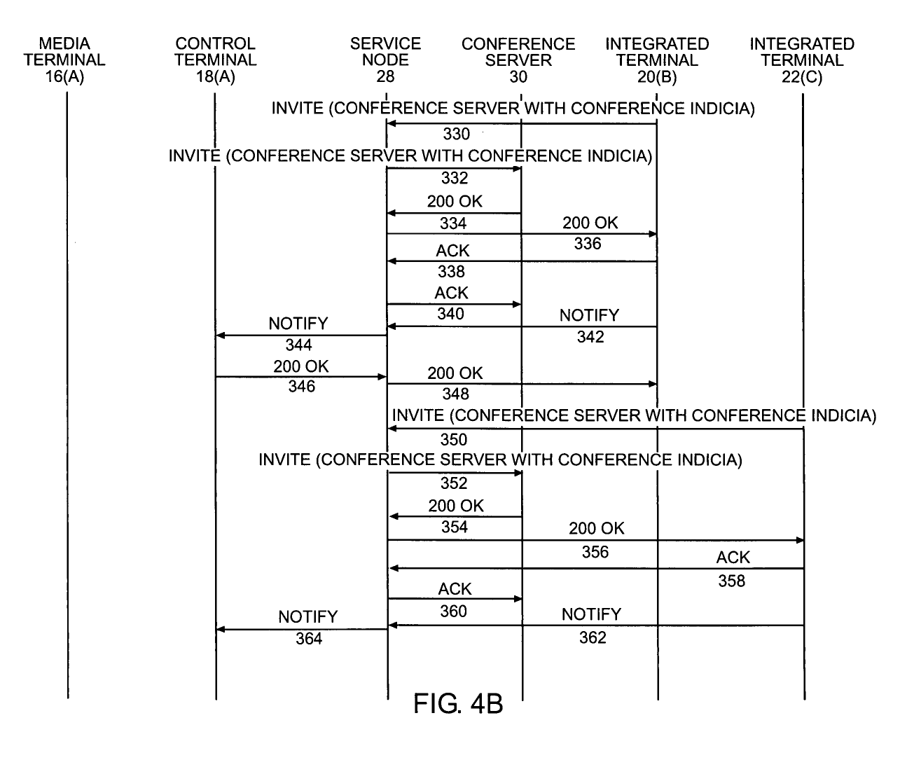

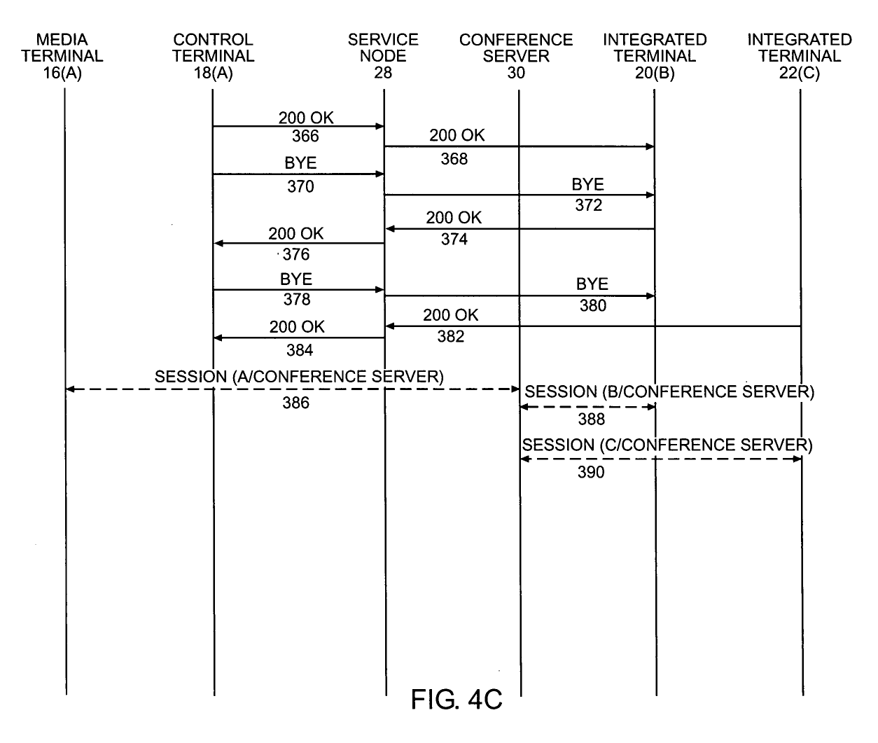

For yet another example, reference is made to FIGS. 4A-4C, wherein a conference call between media terminal 16(A), integrated terminal 20(B), and integrated terminal 22(C) is established. Assume that the conference call will be supported by the conference server 30, which will support three different sessions to media terminal 16(A), integrated terminal 20(B), and integrated terminal 22(C). Further assume that a first session is established for a call between media terminal 16(A) and integrated terminal 20(B), and a second session is established for a call between media terminal 16(A) and integrated terminal 22(C) (steps 300 and 302). Further assume that both calls for the first and second sessions are on hold pending a transfer to the conference server 30 to initiate the conference call.

User A may interact with control terminal 18(A) to initiate transfer of the first and second sessions to the conference server 30 as well as initiate a session between media terminal 16(A) and the conference server 30. In response, control terminal 18(A) will send an Invite intended for the conference server 30 with information pertaining to the participating conference entities: media terminal 16(A), integrated terminal 20(B), and integrated terminal 22(C) (step 304). The service node 28 will forward the Invite to the conference server 30 (step 306), which will respond by sending conference indicia back to the service node 28 in a 200 OK message (step 308). The conference indicia may include the conference server's media capabilities, as well as address, port, conference identifier, conference password, or other conference-related information. The service node 28 will send a Re-Invite message including the conference server's media capabilities to media terminal 16(A) to retrieve the call (step 310). Media terminal 16(A) will respond by sending a 200 OK message to the service node 28 with the media capabilities of media terminal 16(A) (step 312). The service node 28 will then send an acknowledgement message in response to receiving the 200 OK message to media terminal 16(A) (step 314), and will also send a 200 OK message including the conference indicia to control terminal 18(A) (step 316). Control terminal 18(A) will then send an acknowledgement to the 200 OK message back to the service node 28 (step 318).

Having received the media capabilities of media terminal 16A, the service node 28 may forward an acknowledgement message in response to the 200 OK message of step 308 that includes the media capabilities of media terminal 16(A) to the conference server 30 (step 320). At this point, control terminal 18(A) may provide status information bearing on the state of the conference transfer to User A and initiate transfers of the first and second communication sessions, which are on hold, to the conference server 30. Accordingly, control terminal 18(A) will send a Refer message to transfer User B to the conference server 30 using the conference indicia to the service node 28 (step 322). Similarly, control terminal 18(A) will send a Refer message referring User C to the conference server 30 using the conference indicia to the service node 28 (step 324). The service node 28 will send corresponding Refer messages to both integrated terminal 20(B) and integrated terminal 22(C) (steps 326 and 328). The Refer messages will include the conference indicia, which is sufficient to allow integrated terminal 20(B) and integrated terminal 22(C) to establish sessions with the conference server 30 as well as gain access to the conference in an automatic fashion, perhaps using an appropriate conference identification and password.

Integrated terminal 20(B) will then send an Invite toward the conference server 30 via the service node 28 (steps 330 and 332). The Invites will include the conference indicia. In response, the conference server 30 will send a 200 OK message, which is sent to integrated terminal 20(B) via the service node 28 (steps 334 and 336). Integrated terminal 20(B) will send an acknowledgement to the conference server 30 via the service node 28 (steps 338 and 340). Integrated terminal 20(B) can then send a Notify message to the service node 28 indicating that integrated terminal 20(B) has successfully established a session with the conference server 30 for the conference call (step 342). The service node 28 will send a similar Notify message to control terminal 18(A) (step 344), which may provide an alert to User A that User B has joined the conference. Control terminal 18(A) will send a 200 OK message in response to the Notify message to the service node 28 (step 346), which will forward the 200 OK message to integrated terminal 20(B) (step 348).

Next, integrated terminal 22(C) will send an Invite to the conference server 30 via the service node 28 (steps 350 and 352). Again, the Invites will include the conference indicia for the conference call, and provide information sufficient for integrated terminal 22(C) to establish a session with the conference server 30 as well as gain access to the conference. Upon receiving the Invite, the conference server 30 will send a 200 OK message back to integrated terminal 22(C) via the service node 28 (steps 354 and 356). Integrated terminal 22(C) will then send an acknowledgement message back to the conference server 30 via the service node 28 (steps 358 and 360).

To indicate that integrated terminal 22(C) has established a session with the conference server 30, a Notify message is sent to the service node 28 (step 362), which will send a corresponding Notify message to control terminal 18(A) (step 364). Control terminal 18(A) may provide an alert to User A that User C has joined the conference. A 200 OK message is then forwarded from control terminal 18(A) to integrated terminal 20(B) by the service node 28 (steps 366 and 368). Control terminal 18(A) will recognize that User B and User C have joined the conference, and the first and second communication sessions may be ended.

As such, a Bye message is sent to the service node 28 from control terminal 18(A) to end the first session (step 370). The service node 28 will send a Bye message to integrated terminal 20(B) to release the session (step 372). A 200 OK message is then sent through the service node 28 to control terminal 18(A) from integrated terminal 20(B) (steps 374 and 376). Control terminal 18(A) will then send a Bye message to release the second session (step 378). The Bye message is received at the service node 28 and sent to integrated terminal 22(C) (step 380), which will respond with a 200 OK message (step 382). Upon receipt of the 200 OK message, the service node 28 will send a 200 OK message to control terminal 18(A) to effectively release the second session (step 384). Control terminal 18(A) may provide an alert to User A that the first and second sessions are complete and that User A is ready to join the conference.

At this point, the media capabilities of media terminal 16(A) and the conference server 30 have been exchanged such that a session between media terminal 16(A) and the conference server 30 may be established (step 386). Further, separate sessions with the conference server 30 from integrated terminal 20(B) and integrated terminal 22(C) are facilitated (steps 388 and 390). Accordingly, control terminal 18(A), which is associated with media terminal 16(A), is able to effectively transfer multiple sessions to the conference server 30 and provide sufficient information to the service node 28 to allow a conference to be readily established between media terminal 16(A), integrated terminal 20(B), and integrated terminal 22(C).

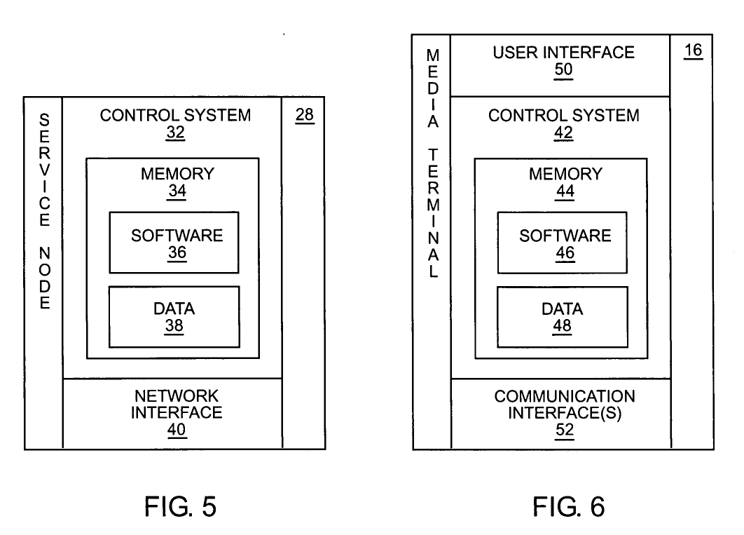

With reference to FIG. 5, a block representation of a service node 28 is illustrated. The service node 28 may include a control system 32 having sufficient memory 34 for the software 36 and data 38 to operate as described above. The control system 32 may also be associated with a network interface 40 to facilitate communications with the various entities and communication terminals with which communications are required.

With reference to FIG. 6, a block representation of a media terminal 16 is illustrated. The media terminal 16 may include a control system 42 having sufficient memory 44 for the software 46 and data 48 to operate as described above. The control system 42 may be associated with one or more communication interfaces 52 to facilitate communications with an appropriate access network 14, and a user interface 50 to facilitate interaction with a user and support audio, video, or voice communications.

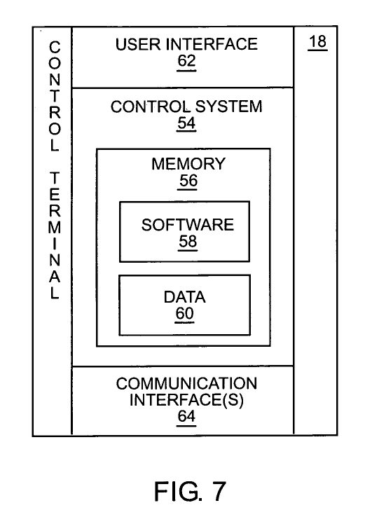

With reference to FIG. 7, a block representation of a control terminal 18 is illustrated. The control terminal 18 may include a control system 54 having sufficient memory 56 for the software 58 and data 60 to operate as described above. The control system 54 may be associated with one or more communication interfaces 64 to facilitate communications with an appropriate access network 14, and a user interface 62 to facilitate interaction with a user and support audio, video, or voice communications.

Those skilled in the art will recognize improvements and modifications to the preferred embodiments of the present invention. All such improvements and modifications are considered within the scope of the concepts disclosed herein and the claims that follow.

What is claimed is:

1. A communication terminal comprising:
at least one communication interface; and
a control system associated with the at least one communication interface and adapted to:
receive from a service node session indicia bearing on a first communication session established or being established with a media terminal, the first communication session not established or being established with the communication terminal; and
control the first communication session via the service node.

2. The communication terminal of claim 1 wherein the control system is further adapted to provide an additional service associated with the first communication session.

3. The communication terminal of claim 2 wherein the additional service is unavailable or difficult to employ without implementation by the communication terminal.

4. The communication terminal of claim 1 further comprising a user interface associated with the control system, the control system further adapted to establish a second communication session wherein the first and second communication sessions form a multimedia communication session.

5. The communication terminal of claim 4 wherein the control system is further adapted to control the second communication session.

6. The communication terminal of claim 1 wherein the session indicia comprises control information used to control the first communication session.

7. The communication terminal of claim 1 wherein the session indicia comprises identification information identifying at least one of the group consisting of the first communication session, the media terminal, a remote terminal associated with the first communication session, a first user associated with the media terminal, and a second user associated with the remote terminal.

8. The communication terminal of claim 7 wherein at least a portion of the identification information is presented to the first user via the communication terminal.

9. The communication terminal of claim 1 wherein to control the first communication session the control system is adapted to initiate a transfer of the first communication session from the media terminal to another terminal by sending a control message to the service node.

10. The communication terminal of claim 1 wherein to control the first communication session the control system is adapted to initiate a transfer of the first communication session and at least one other communication session from the media terminal to a conference server by sending a control message to the service node.

11. The communication terminal of claim 1 wherein the service node is adapted to establish the first communication session and provide the session indicia to the communication terminal during or upon establishment of the first communication session to effectively transfer control of the first communication session to the communication terminal.

12. A method of operating a communication terminal as a control terminal comprising:
receiving from a service node session indicia bearing on a first communication session established or being established with a media terminal, the first communication session not established or being established with the communication terminal; and
controlling the first communication session via the service node.

13. The method of claim 12 further comprising providing an additional service associated with the first communication session.

14. The method of claim 12 wherein the additional service is unavailable or difficult to employ without implementation by the communication terminal.

15. The method of claim 12 further comprising providing a user interface and establishing a second communication session, wherein the first and second communication sessions form a multimedia communication session.

16. The method of claim 15 wherein the communication terminal is further adapted to control the second communication session.

17. The method of claim 12 wherein the session indicia comprises control information used to control the first communication session.

18. The method of claim 12 wherein the session indicia comprises identification information identifying at least one of the group consisting of the first communication session, the media terminal, a remote terminal associated with the first communication session, a first user associated with the media terminal, and a second user associated with the remote terminal.

19. The method of claim 18 wherein at least a portion of the identification information is presented to the first user via the communication terminal.

20. The method of claim 12 wherein to control the first communication session, further comprising initiating a transfer of the first communication session from the media terminal to another terminal by sending a control message to the service node.

21. The method of claim 12 wherein to control the first communication session, further comprising initiating a transfer of the first communication session and at least one other communication session from the media terminal to a conference server by sending a control message to the service node.

22. The method of claim 12 wherein the service node is adapted to establish the first communication session and provide the session indicia to the communication terminal during or upon establishment of the first communication session to effectively transfer control of the first communication session to the communication terminal.

23. A method comprising:
effecting establishment of a first communication session between a media terminal associated with a first user and a remote communication terminal;
providing session indicia to a control terminal associated with the first user;
receiving control indicia from the control terminal for controlling the first communication session; and
effectively controlling the first communication session based on the control indicia received from the control terminal.

24. The method of claim 23 further comprising effecting establishment of a second communication session involving the control terminal, wherein the first and second communication sessions are part of a multimedia communication session.

25. The method of claim 23 further comprising:
receiving additional control indicia from the control terminal for implementing an additional service associated with the first communication session; and
effecting implementation of the additional service associated with the first communication session.
